(19) United States
(12) Patent Application Publication
(10) Pub. No.: US 2014/0178846 A1
(43) Pub. Date: Jun. 26, 2014

(54) System and Method for Interactive Education and Management

(71) Applicant: Healthcare Technologies and Methods, LLC, Purcellville, VA (US)

(72) Inventors: Alan M. Letzt, Purcellville, VA (US); Stephanie P. Letzt, Purcellville, VA (US); Thomas M. Welsh, Fairfax Station, VA (US)

(21) Appl. No.: 14/135,701

(22) Filed: Dec. 20, 2013

Related U.S. Application Data
(60) Provisional application No. 61/745,616, filed on Dec. 23, 2012.

(51) Int. Cl. G09B 5/06

(52) U.S. Cl. CPC G09B 5/06
USPC 434/308

(57) ABSTRACT

A method and system for interactive education and management that includes storing, by a server including a processor, a plurality of different items of media content. The server receives first user input from at least one first user, associates at least one item of media content of the plurality of different items of media content with at least one second user of a plurality of different second users based at least partly on the first user input, associates at least one other item of media content of the plurality of different items of media content with at least one other second user of the plurality of different second users based at least partly on the first user input, and provides the at least one item of media content to reproduction equipment of the at least one second user for reproducing the at least one item of media content.

### CROSS REFERENCE TO RELATED APPLICATIONS

This application claims the benefit of U.S. Provisional Application No. 61/745,616, filed Dec. 23, 2012, the disclosure of which is hereby incorporated in its entirety by reference.

### BACKGROUND OF THE INVENTION

1. Field of the Invention

Preferred and non-limiting embodiments are related to educating users and tracking their progress and, in particular, to utilizing Internet, television, and telephone technologies to enable patients to receive healthcare education and report their progress using any television and a remote control.

2. Description of Related Art

Providing effective education and reinforcement to patients with chronic illnesses for improved self-management is important and complicated. It is equally important and challenging to provide timely and accurate information about a patient's progress to responsible healthcare providers. Because one of the major costs in healthcare is a result of avoidable hospital readmissions, a system to facilitate at-home self-care education and reinforcement, improved patient self-management, and more timely and accurate status reporting, has the potential to reduce costs and improve the quality of healthcare.

Traditional methods of educating patients include verbal instructions, printed brochures, and videos, as well as websites that are accessed by computers and mobile electronic appliances. The challenges of educating patients about their chronic illnesses using these methods include variations among patients in age, language, reading ability, hearing ability, visual acuity, and other factors that impact comprehension and memory. Another major challenge is that a large percentage of the least healthy patients are older and have few, if any, computer skills. Traditional methods of tracking a patient's status include self-reporting to the healthcare provider, whether in person or via websites or telephone. Other methods, which may be very costly and viewed as intrusive, include use of a variety of sensors in the patient's home to monitor their condition and movements.

One method of communication that is very familiar to all segments of patients, but is underutilized in healthcare education and status reporting, is television. Advantages of television technology in this application include: (a) most television viewers are able to use the basic functions on a television's remote control; (b) the screen of a typical home television is large enough to view videos and text comfortably; and (c) many of the least healthy patients are at home a large portion of the day and are accustomed to watching television shows as part of their daily routine.

U.S. Pat. No. 5,951,300 discloses an on-line health education program that includes personalized health content and patient-selected entertainment. Although this conventional program provides information to patients, it requires the patient to have a computer and computer-related skills, does not allow the patient to modify scheduling parameters to account for personal schedule changes, and does that ensure that the information provided to the patient is up to date.

U.S. Pat. No. 5,544,649 discloses an interactive television and audio patient monitoring system that connects a patient at home with a central monitoring station manned by health practitioners using two-way interactive cable television. This conventional monitoring system requires the healthcare professional to be available to operate the system and interact with the patient during each use, and for the patient to provide a health status report when the provider is not available.

U.S. Pat. No. 6,144,837 discloses a modified CD-ROM multimedia interactive television video game console to which a television and physiological data monitors are coupled to provide measurements of parameters such as blood pressure, and to provide sound and a video display. U.S. Pat. No. 6,209,025 integrates Internet services and telephony services with a television to generate pop-up windows that are inserted into the TV image simultaneously with existing entertainment content. However, there is a need for television-related technology that does not distract and confuse the patient with multiple simultaneous images, because healthcare education may require complete patient concentration.

U.S. Pat. No. 7,908,630 discloses a method which allows a sender to place a phone call to a recipient and to direct information to the recipient's cable television set. The phone call is used to provide permission for a TV data transmission to be completed and viewed by the recipient. Because patients' schedules are variable, there is a need for a method that allows the patient to receive and interact with television-based content that is independent of a permission-granting phone call.

Conventional interactive TVs that may be linked to hospital servers or that promote home shopping and video games do not provide healthcare videos and messages selected for the patient's needs, either on demand, or at times, generally convenient for the patient—downloaded from a server rather than a television network. The patient's convenience and control over viewing and responding to content is not paramount.

### SUMMARY OF THE INVENTION

Generally, provided is a system and method utilizing a technology, e.g., television, that is in 99% of homes and that 99% of people find easy to use. Systems and methods according to preferred and non-limiting embodiments combine and integrate television, Internet and telephone technologies with hardware and software to provide real-time information and alerts to users, e.g., patients, in text, audio and video modes via a television set. Ease of use for patients (especially older patients who have fewer computer skills and a higher percentage of chronic illnesses) is promoted, and education, reinforcement and reporting are integrated into the patient's daily living routine. Health status information and other information may be collected from patients via the television and telephone and the collected information may be automatically transferred to a secure website accessible by a healthcare professional. The healthcare provider, the patient, and other parties who receive permission by the patient are provided with an ability to control the system's content, schedules, data collection, and communications process. The probability that a patient will actually receive a message is increased by: (a) interrupting an active television show; and/or (b) having the television message backed up by an automated telephone call to the patient. It can be appreciated that systems and methods described herein may be modified to convey information and collect data within many areas other than healthcare.

Preferably, provided is a system and method for interactive healthcare education and management utilizing a coordinated operation of a server, an interface unit, a television set or other reproduction equipment including a display and/or speakers, a telephone and a remote control to provide content that educates a patient about healthcare and facilitates communications between the patient and the healthcare provider. However, because of the possible generalized applications in other fields of systems and methods described herein, in the below description, a healthcare provider may simply be referred to as a first user, a patient as a second user, a technician as a third user, and a caregiver or friend of the patient as a fourth user.

Content may include health education information, quizzes on the health education information, health status questions, and any other type of information presented to a patient to further the aims of patient education, self-management and feedback. Content may be in the form of video streams, audio messages, text, and graphics. A type of content may include: scheduled content; unscheduled content; and general content. Scheduled content includes content that can be selected and scheduled for presentation at a particular date and time by a first user on a first user website, and downloaded from a first database in the web server to a second database in an interface unit to be made available for viewing on a TV set at the scheduled date and time by a second user. The scheduled content may also be downloaded to the interface unit with a physical connection when the second user does not have a connection to the Internet. Unscheduled content includes content that is selected and recommended by the first user via a first user website, and downloaded from a first database in the web server to a second database in the interface unit to be made available for viewing on demand on a TV set by the second user, but not scheduled. General content includes content that can be installed, e.g., on the interface unit, but is not selected by the first user via a first user website and is not scheduled, but can be downloaded from a first database in the web server to a second database in the interface unit to be made available for viewing on a TV set on demand by the second user. Examples of general content may include, but are not limited to, educational videos, ad hoc videos recorded by the first user for a specified second user, information presented as text, questions about educational content, questions about a device or equipment used by a second user, and questions about the second user's health status.

According to a preferred and non-limiting embodiment, a system for interactive healthcare education and management includes an interface unit, which includes a local storage device and a server including a processor, which is connected to a server via a network, e.g., the Internet. The interface unit is connected to reproduction equipment, which may be a television or other display.

According to another preferred and non-limiting embodiment, a system for interactive healthcare education and management includes a server and an interface unit including a local storage device and a server. The interface unit is connected to reproduction equipment, which may be a television or other display.

According to still another preferred and non-limiting embodiment, a system for interactive healthcare education and management includes a server, an interface unit including a local storage device, which is connected to reproduction equipment, which may be a television or other display. The server may download content to the interface unit and upload data from the interface unit via a direct connection or via an external memory device. A user may enter user data via the interactive voice response system.

Preferred and non-limiting embodiments of a system and method for interactive healthcare education and management provide a memory for storage of content, and coordinated communications of content and responses to content, between a server and an interface unit with the interface unit being connected to reproduction equipment, e.g., a television, and equipped for receiving signals from a remote control, e.g., the television's remote control. A first user enters instructions about content and scheduling times on the first user website which communicates with the server. A second user may view the content on the television and respond to questions on the television about the content using the remote control. Accordingly, the server may send scheduled and unscheduled content from the first database in the server to the second database in the interface unit, the interface unit may send scheduled content from the second database to the television which displays the content on the television according to the schedule, the interface unit may send unscheduled content from the second database to the television, which displays the content in a queue, and plays the content based on a signal from the remote control operated by the second user, and the second user may use the remote control to interact with the content by responding to prompts or questions on the television screen, with the user responses being stored in the second database on the interface unit and transmitted via the Internet to the first database on the server. Scheduled content includes messages with associated scheduled dates and times, and for recurring content, scheduling time intervals. If the interface unit is not connected to the Internet, content may be stored on an external memory device and data resulting from the second user's viewing of and responses to content can be retrievable from the external memory device. If the interface unit is not connected to the Internet, content may be stored on an external memory device and data resulting from the second user's viewing of and responses to content may be downloaded to the server via a direct physical connection. A keyboard, mouse, touchscreen or other user input device may be connected to the interface unit to perform the same functions as a remote control and other functions, e.g., text entry.

The first user may operate a first user website that is hosted on the server that communicates with the interface unit via the Internet. Using the first user website, the first user selects scheduled content, scheduling times and days, and recommended unscheduled content for viewing by the second user on the television. The content selections by the first user are stored in the first database on the server and transmitted by the server to the interface unit where the content selections and schedules are compared with the content and schedules already stored on the second database. Based on this comparison, the most recent versions of content and schedules are stored on the second database, and out of date versions of content are replaced by the updated content.

The first user may review second user data and second user reports based on the data on the first user website. The second user data, which is based on use of the remote control by the second user, may be viewed by the second user on the television. The second user data is stored on a second database on the interface unit. The second user data is communicated by the interface unit to the server via the Internet, and stored in a first database on the server. The first user's review of the data and reports may influence the second user's actions and communications and may result in the first user changing the content selections and schedules on the first user website. The second user's review of the data and reports may influence the second user's actions and communications and may result in the second user changing content selections and schedules using the remote control.

An electronic medical device, e.g., a blood pressure monitor, may be connected to the interface unit by a wired or wireless connection in order to store the data in the second database located in the interface unit. The stored data can be viewed by the second user on the television and transferred via the Internet to the first database on the server so the data can be viewed by the first user on the first user website.

The second user who is viewing the content on the television may place a phone call to a server using an interactive voice response system to enter responses to questions related to the content and to the second user's status. The second user responses may be entered by telephone key presses or by speaking into the phone to a voice recognition system. The responses are stored in a third database on the server where the responses may be viewed by the first user as data and reports on the first user website; viewed by the second user as data and reports on a cell phone, computer, or other electronic device; or heard by the second user on a telephone.

When content is scheduled, but the second user is already watching other programming, the interface unit may send a message to the television that appears on the screen. The message informs the second user of the scheduled content and gives the second user viewing options, for example, “view content now”, “display content at a later time”, and “do not display content today”. The second user may respond by selecting one of the options using the remote control, or by allowing the message to time out so that the system executes a pre-programmed time out option, e.g., a “display the content” option or a “return to viewing” option.

The first user may select operational options on the first user website, and the options may be downloaded by the server to the interface unit. The options that may be activated by the interface unit when content is scheduled but the television is turned off, may include: (a) the interface unit sends a message to the television to turn itself on automatically and display the scheduled content; (b) the interface unit sends a message to the server to schedule a reminder telephone call to the second user using the interactive voice response system; and (c) the interface unit sends a message to the server to schedule a reminder e-mail or text message to be sent to the second user.

When the second user responds to questions or prompts on the television by using the television remote control, and views the content, the second user response data and usage data are transmitted from the interface unit to the server via the Internet and the server analyzes the data continuously. The data may be transferred to the server by connecting the Interface unit to a computer that is connected to the Internet, or by transferring the data from the interface unit to an external memory device that downloads the data to the server, or by wirelessly transferring the data from the interface unit to a website on a computer that is connected to the Internet. The data analyses on the server may result in actions by the server including: (a) adding new content and scheduling times to the first database on the server, with the content and scheduling times transmitted via the Internet to the second database on the interface unit; (b) deleting content and scheduling times from the first database on the server, with the content and scheduling times changes transmitted via the Internet to the second database on the interface unit; (c) issuing alert messages to the first user on the first user website, or by telephone, e-mail or text messages; (d) issuing alert messages to the second user on the television or by telephone, e-mail or text messages. Additionally or alternatively, data analyses may be performed by the interface unit.

The first user website may allow the first user to select and schedule content, set alert limits, and review reports, and the television may allow the second user to view and respond to content, alerts and reports. A technician or other authorized person may configure the interface unit to be compatible with the television and to activate one or more features on the interface unit by using the remote control with the interface unit and television, or by using a website that communicates with the interface unit, or by using a mobile device, e.g., a smart phone. The functions that are available on a television set may be available on a computer, a mobile computing device, a mobile communications device, or a device that is comprised of two or more of these computing and/or communications features.

The server(s) include a computer used for the creation, modification, storage, and communication of information. The server may be used to collect, store, and present information entered by the first and second users. One illustrative example of a web server is a PowerEdge R515 2U Rack Server with Windows Server operating system and Microsoft SQL Server database management software. The server may communicate with the second user's telephone and other communications device to provide automated phone calls, e-mails, and text messages that remind the second user to view content and to respond to the content by answering questions about their status and the information that they learned from the content.

The television that is used by the second user and the computer that is used by the first user may be replaced with other electronic devices that have displays, e.g., computer monitors, computers with a variety of formats, e.g., desktops, laptops and tablets, and mobile communications devices including smart phones. The interface unit may be packaged in a set-top box or integrated into or inserted in another component, e.g., television, or the interface unit may be integrated into an existing set-top box with other functionalities. The television remote control may use technologies including infrared (IR) or radio frequency (RF), and pushbutton remote controls may be replaced by alternative means of controlling the television remotely including remotes and smart phones that accept voice commands. Videos and other content may be streamed from a server to the interface unit or directly to the second user's television.

The server may be connected directly to the television via a satellite or cable TV service. The server may comprise software that is resident on and executing in the central servers of the satellite or cable TV provider and the interface unit may only be used as an interface for a medical device function.

A camera may be included in the interface unit to allow the second user to create and download images and videos, view the images and videos on the second user's television, and automatically transmit the images and videos to the first user. The interface unit may provide videoconferencing between a first and second user. Audio content may be delivered from the server to the second user via a version of telephone technology.

The first user may use a video recording device to create a video with instructions for the second user, and the second user may download the video to the server. The video recording device may be independent of, or associated with, the first user's computer. The video may be identified by the server as new content which may be downloaded from the server to the interface unit and made available to the second user on the second user's television. The first user may develop questions on the first user website that are associated with, and downloaded with, the video for answering by the second user. The second user responses are stored in the second database in the interface unit and transmitted via the Internet to the server where the responses are stored and accessible on the first database in the first user website.

A first user may record audio comments that can be stored on the server or interface unit and played on the television by the second user. The audio comments may be associated with specific content, e.g., a video, appointment reminder or discharge instructions, or may be categorized as general comments that can be listened to by a second, third or fourth user on demand.

The first user may update any content on the first user website, and the updates may be transmitted from the server to the interface unit to the second user's television. The second user may add new content to the interface unit and schedule the new content using the remote control or a smart phone. The second user may wear or carry a GPS device that communicates with the interface unit so that the first user can track the second user's location on the first user website, and a fourth user can track the second user's location on the second user's television.

A system and method according to a preferred and non-limiting embodiment may be integrated into a “medical home” to coordinate care of the second user. A “primary” first user may authorize additional first users to access the first user's website. The primary first user may authorize additional second users and third users to use the television that is connected to the interface, and authorize third users and fourth users to access the third user's website and fourth user's website, respectively. The second user data may be integrated with the first user appointment calendars to enable the scheduled content that notifies the second user of appointments and track the keeping of appointments. Content may be provided to more than one second user at the same time in a group setting.

The second user data may be transmitted to the first user's server and/or to a central server with a central database. The central database may include an electronic medical record system or another form of a central database. The software on the central server may include a geographic information system that can analyze the data from one or more second users by geographic, demographics, and other variables of interest, and display the data and analyses on a monitor or mobile device for review by an individual or group of individuals. The central database may present reports of individual second user data and/or reports of aggregated data from two or more second users or second users from two or more geographic locations.

The television may be located in an institutional setting, e.g., a hospital, and the server may include any of the server related functions discussed above and the functions of the interface unit. The server may provide the functions thereof to one or a multiplicity of first users and to one or a multiplicity of second users. If a second user leaves the institutional setting to return home, the second user's home may be modified for continued use of the system by the second user and for communication with one or more first users.

The first user may identify content that is most important for the second user to access and may prioritize the content for the second user. The selection and prioritization of content by the first user may be completed for an identified group of second users with common needs or individually and independently for each second user. The content may be displayed on the television as a “play list”, and/or may be organized by categories that may be controlled by the primary first user, or pre-assigned by the system, or defined by the first user using the first user website, or defined by the second user using the remote control.

The server and/or interface unit may include adaptive logic to select or deselect content for the second user based on the second user data (e.g., usage data, downloaded data from meters, and answers to questions). The server and/or interface unit may provide content for the second user that explains the correct response to a question and the reasoning behind the correct response. The first user may override the adaptive logic and/or add additional content or delete recommended content. The interactive voice response system operation may be coordinated with the interface unit operation based on the second user data. The coordination may include the placing of automated telephone calls to the second user to schedule content viewing by the second user or to schedule entry of data by the second user using the telephone interactive voice response system or the television remote control.

The second user may use the remote control to slow down or speed up the content, without distortion of audio or visual content, to enable the content to be more comprehensible and comfortable to view and listen to. An analysis of a record of incorrect responses by the second user by the server or interface unit may result in the interface unit or server automatically issuing instructions to slow down or speed up the content. An analysis of a record of incorrect responses by the second user by the server or interface unit may result in the interface unit or server automatically changing the content to similar content with a different health literacy level and providing new content with definitions and explanations for complex terminology and concepts. A second user may be able to access interactive training content that helps the second user operate the remote and the system more effectively.

The second user may be required to enter a pass code to access the content to verify which users are using the system or to differentiate data between two second users in the same home using the same system. Alternatively or additionally, the second user may be required to use a biometric identification system to access the content before the content is transmitted from the interface unit to the television.

The second user may receive a message on the television or a voice message via an interactive voice response telephone call that provides information including: content viewed to date by the second user, content scheduled for the next viewing by the second user and scheduled viewing time, description of content; and a report of second user data (e.g., usage data, downloaded device data, and answers to questions). The second user may be able to use the remote control to adjust the font size of print content on the television.

The first user may use the first user website to select limits for the desired second user data (e.g., usage data, downloaded device data, and answers to questions), and when the second user's data falls outside the selected limits, the server triggers an alert message to the first user. The alert message is displayed on the first user website, and may be transmitted by the server to the first user or other designated users via telephone, e-mail, text message, or another communication method. The first user, using the first user's website, may establish and modify the alert rules (e.g., the pattern and frequency of data that triggers an alert) for one second user or a group of second users. The server and/or interface unit may record that an alert has been received by a first user on a first user website or other device that received the alert and acted upon by the first user based on a recorded input by the first user. The server and/or interface unit may record that an alert has been received by a second, third or fourth user on a website or other device that received the alert, and acted upon by the user based on a recorded input by the user.

A second, third or fourth user may use the remote control to make appointments or order supplies (including medications) or equipment displayed on the television and the requests are transmitted to a medical provider or supplier of the ordered supplies or equipment via the interface unit and a server. The requests may be placed based on second, third or fourth user responses to questions about the need for an appointment or the use of supplies or equipment that indicate that a professional consultation or new supplies or equipment or refills are needed.

The interface unit functions and features may be incorporated into other technology, for example, the patient's television, another interface unit with additional functionality, or a server. The remote control device that controls the interface unit may be the same or a different remote control device that is used to control the television. The remote control device can also be a smart phone or a tablet computer or another electronic device. The second user's television set may be replaced by an alternative display or a device, e.g., a tablet computer or a smart phone.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

Further features and other objects and advantages will become apparent from the following detailed description made with reference to the drawings in which:

FIG. 1 is a block diagram of a system for interactive education and management according to a preferred and non-limiting embodiment;

FIG. 2 is a block diagram of software/hardware interaction for a system for interactive education and management according to a preferred and non-limiting embodiment;

FIG. 3 is a block diagram of an interface unit according to a preferred and non-limiting embodiment;

FIG. 4 is a flowchart of a method for interactive education and management according to a preferred and non-limiting embodiment in which a user interacts with a television and an interface unit when content is scheduled by a server;

FIG. 5 is a flowchart of a method for interactive education and management according to a preferred and non-limiting embodiment in which a user interacts with a television and an interface unit to schedule content;

FIGS. 6A and 6B are flowcharts of a method for interactive education and management according to a preferred and non-limiting embodiment in which a provider interacts with a server and receives alerts from the server when the alerts are generated by a user interacting with the television; and

FIG. 7 is a flowchart of a method for interactive education and management according to a preferred and non-limiting embodiment in which an interface unit provides video caching.

### DETAILED DESCRIPTION OF THE DISCLOSED EMBODIMENTS

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that may be wired and/or wireless in nature. Additionally, two units or components may be in communication with each other even though the data transmitted may be modified, processed, routed, and the like, between the first and second unit or component. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. It will be appreciated that numerous other arrangements are possible.

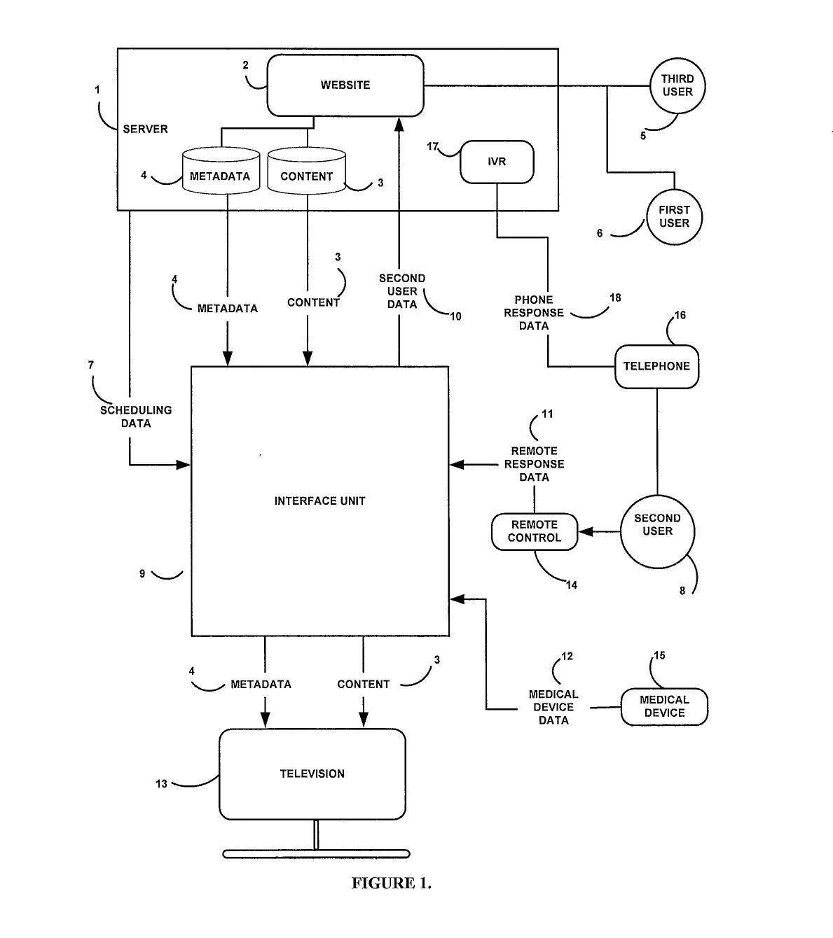

FIGS. 1-7 illustrate a system and method for interactive education and management. An interactive television (ITV) system for healthcare education and management may comprise hardware and software components illustrated in FIGS. 1-7. It will be appreciated that disclosed embodiments may vary as to the details of elements of systems, and steps of methods may vary as to the specific steps and the sequence of steps without departing from the basic concepts disclosed by preferred embodiments. Although, preferred embodiments are described with respect to an application in healthcare education and management, it can be appreciated that other applications of preferred embodiments are possible.

FIG. 1 is a block diagram of a system for interactive education and management according to a preferred and non-limiting embodiment. A server 1 is connected to a network, e.g., the Internet, and hosts a first user website 2, stores content 3, and metadata 4. A third user 5 loads content 3 on the ITV server 1. The website 2 enables the first user 6 to select content 3, metadata, 4, and scheduling data 7 to be associated with a second user 8 and transmitted via the Internet to be stored on the interface unit 9. Second user data 10 may include a combination of remote response data 11 and medical device data 12. The website 2 receives second user data 10 from the interface unit 9 via the Internet, and displays the second user data 10 in reports that can be viewed by the first user 6. Reports containing second user data 10 can also be viewed by the second user 8 on television 13.

The interface unit 9 sends content 3, and metadata 4 to the television 13 so that the second user 8 can view the content 3 on the television 13. Scheduled content is sent to the television 13 according to the scheduling data 7. Unscheduled content is sent from the interface unit 9 to the television 13 when a signal from remote control 14 is sent to the interface unit 9. It can be appreciated that some of the content selected by the second user 8 may not be associated with a scheduled day or time and is available for viewing by the second user 8 at the second user's convenience.

When the second user 8 views the content 3 on the television 13, the second user 8 may respond to the content 3 using the remote control 14 such that remote response data 11 is transmitted to and stored on the interface unit 9. If a medical device 15 is connected by a wired or wireless connection to the interface unit 9, the device data 12 is transmitted to and stored on the interface unit 9.

The second user 8 may use a telephone 16 to call into an interactive voice response (IVR) system 17 of the server. The second user 8 enters phone response data 18 via voice response or key entry and the phone response data 18 is stored on the server 1.

A system for interactive healthcare education and management may be configured by connecting the interface unit 9 to the television 13 via an appropriate cable, e.g., an HDMI cable, connecting the interface unit 9 to the Internet, and selecting desired operational options displayed by the interface unit 9 on the television 13.

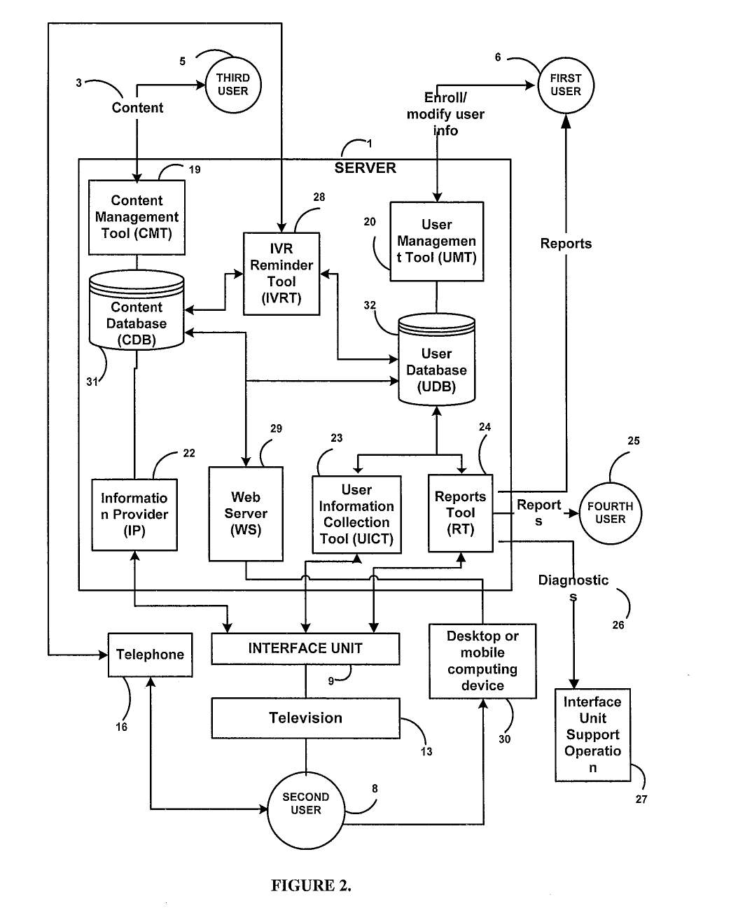

FIG. 2 is a block diagram of software/hardware interaction for a system for interactive education and management according to a preferred and non-limiting embodiment. The server 1 comprises a Content Management Tool (CMT) 19 including a web-based software program used by a third user 5 to add, modify, and/or delete content 3 stored in a content database (CDB) 31 on the server 1. The CMT 19 includes forms that enable the third user 5 to upload content 3 to the server, and to categorize the content 3 by, for example, topic, date, etc. The CMT 19 may be written in a programming language such as Java, and may communicate using standard browser protocols.

The server 1 comprises a User Management Tool (UMT) 20 including a web-based software program used by a first user 6 to enroll and add information about each second user 8. The enrollment forms include fields for the second users' 8 information, e.g., name, contact information, and demographic information. The first user 6 may use the UMT 20 to select and schedule content 3 for the second user 8. The UMT 20 may be written in a programming language such as Java, and may communicate using standard browser protocols.

The server 1 comprises an Information Provider (IP) 22 including a web-based software program used to provide content 3 to the second user 8 via the interface unit 9. The IP 22 responds on demand to requests from interface unit 9 to download content 3 that is either scheduled or requested by the second user 8 using the remote control 14. The IP 22 may be written in a programming language such as Java, and may communicate over network sockets.

The server 1 comprises a User Information Collection Tool (UICT) 23 including a web-based software program used to collect second user data 10 transmitted from the interface unit 9. The UICT 23 enables the second user 8 to request content 3, and enables content 3 to be delivered to the interface unit 9 at a scheduled date and time. The UICT 23 may be written in a programming language such as Java, and may communicate over network sockets.

The server 1 comprises a Reports Tool (RT) 24 including a web-based software program used to format and display second user data 10. The RT 24 comprises web-based forms that enable the first user 6 to select a report for a specified second user 8. The first user 6 may direct reports to be sent to the second user 8 and a fourth user 25. The RT 24 may send diagnostics 26 to an Interface Unit Support Operation 27 for analysis. The RT 24 may be written in a programming language such as Java, and may communicate using standard browser protocols.

The server 1 comprises an Interactive Voice Response Reminder Tool (IVRT) 28 including a software program that may be integrated with the IP 22 and that automatically places a reminder call to the second user 8 on the telephone 16 when the television 13 is turned off or when the second user 8 is not responsive to the content 3. The IVRT 28 may provide the content 3 as an audio message that can be heard by the second user 8. The IVRT 28 may be developed in a telephony language such as Envox Studio.

The server 1 comprises a Web Server (WS) 29 including a web-based software program that provides content 3 and accepts responses generated by the second user 8 on the first user website 2 via a standard browser. The WS 29 may be written in a programming language such as Java, and may communicate using standard browser protocols. The second user 8 may interact with the WS 29 via a desktop computer or mobile computing device 30 to perform the same activities that the second user 8 can perform via the television 13.

The CDB 31 stores and categorizes content 3. The CDB 31 may be implemented in database management software such as Oracle.

The server comprises a User Database (UDB) 32 that stores and categorizes second user data 10. The UDB 32 may be implemented in database management software such as Oracle.

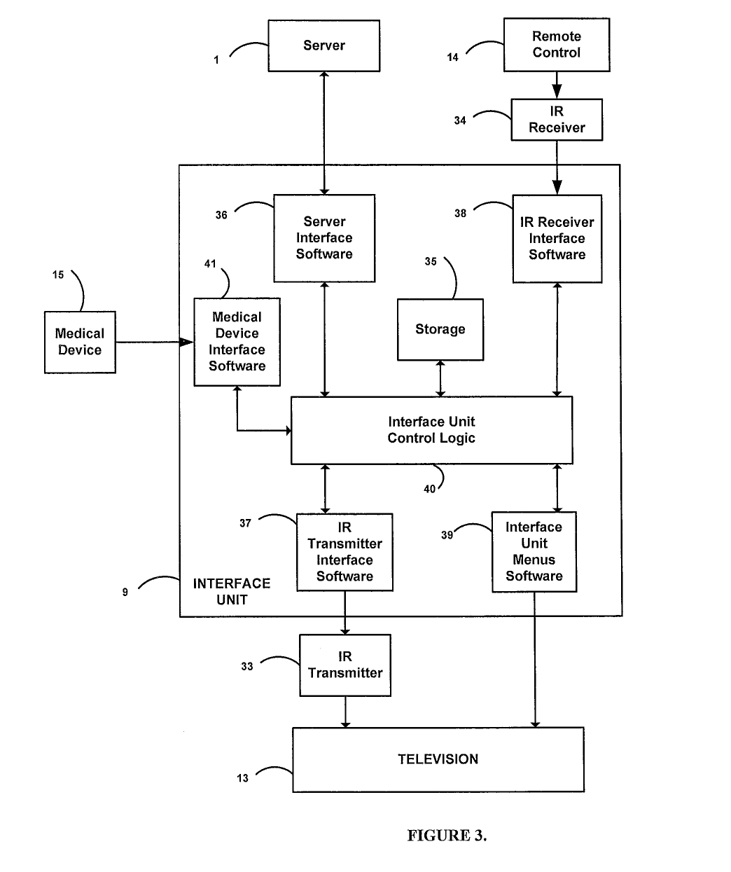

FIG. 3 is a block diagram of an interface unit according to a preferred and non-limiting embodiment. The interface unit 9 comprises an electronic device that is connected to the television 13 and receives information from the server 1. The interface unit 9 may be configured with an embedded operating system, e.g., Linux. The interface unit 9 interrupts commercially broadcast television programming to display content 3 to be viewed by the second user 8 (FIG. 1). Alternatively or additionally, the second user 8 may request content 3 by using the remote control 14 to access the content 3 stored in the interface unit database (FIG. 1). The interface unit 9 may be assembled from standard components including a motherboard, disk drive, power supply, and/or chassis. The interface unit 9 may include an IR transmitter 33 to control the television 13 and an IR receiver 34 to receive commands from the remote control 14. The interface unit 9 may include ports and wireless data collection components, e.g., Bluetooth receivers, to collect device data 12 (FIG. 1) from the second user's medical device 15, and storage 35, e.g., a hard disk drive and/or memory, to store interface unit software, content 3, and second user data 10.

The interface unit software may be written in a programming language such as Java. The interface unit software comprises: a server interface module 36 that sends second user data 10 to the server 1 and receives content 3 and metadata 4 from the server 1; an IR transmitter interface module 37 that sends commands via an infrared (IR) transmitter to the television 13; an IR receiver interface module 38 that receives commands from the remote control 14; an interface unit menu module 39 that displays menus on the television 13 and processes menu selections made by the second user 8; and an interface unit control logic module 40 that controls the operations of the interface unit 9 and the modules thereof. The interface unit control logic 40 may include a self-diagnostics module that reports interface unit diagnostics to the server and/or a medical device interface module 41 that interacts with the second user's medical device 15 and transmits device data 12 via the server interface 36 to the server.

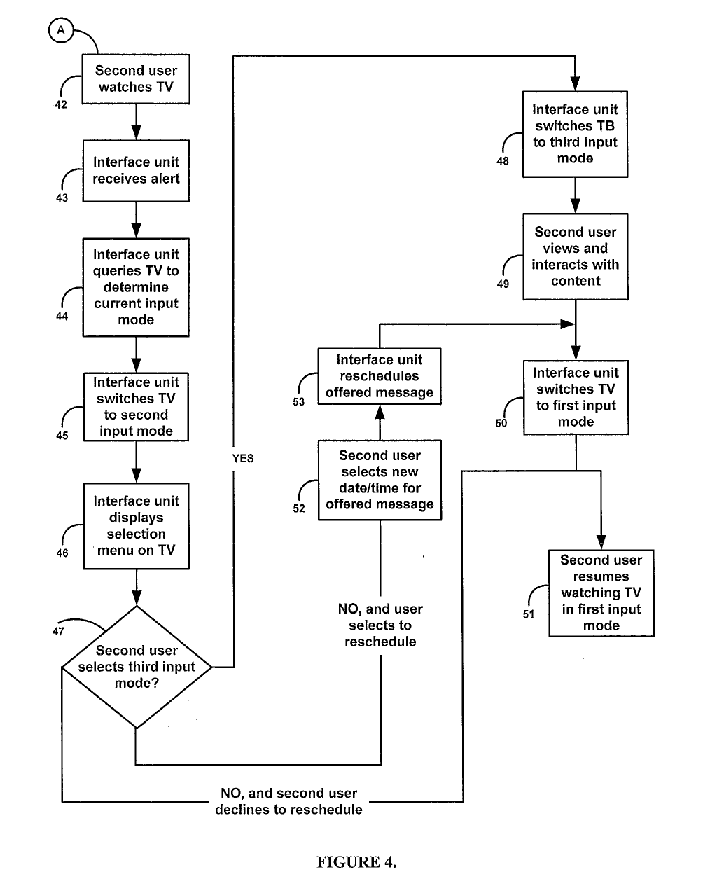

FIG. 4 is a flowchart of a method for interactive education and management according to a preferred and non-limiting embodiment in which a user interacts with a television and an interface unit when content is scheduled by a server. In block 42, the second user 8 watches the television 13 in a first mode. In block 43, the interface unit 9 receives a scheduled content alert that signifies that a time for scheduled content has arrived. For example, scheduled content may be a reminder for a patient with diabetes to check both feet and include a scheduled video on foot care. In block 44, the interface unit 9 queries the television 13 to determine the current operational mode and the current video input, which may be, for example, a commercial television show or a movie via a DVD. In block 45, the interface unit 9 changes the television's operational mode to a second mode. In block 46, the interface unit 9 displays a selection menu on the television 13, the selection menu including options for the second user 8, for example: (a) I want to view the content now; (b) I want to view the content at a later time today; and (c) I do not wish to view the content today, but I would like to be reminded tomorrow at the same time.

In block 47, the second user 8 selects one of the options presented by the selection menu. For example, if choice (a) is selected, the interface unit 9 switches the television 13 in block 48 to a third operational mode and, in block 49, the second user 8 views and interacts with the content 3. If the second user 8 indicates using the remote control 14 that the second user 8 is finished watching and interacting with the content 3, the interface unit 9 switches the television 13 to the first operational mode in block 50 and, in block 51, the second user 8 resumes watching broadcast television shows.

If choice (b) is selected in block 47, the second user 8, in block 52, views a menu that enables user selection of a new viewing time. In block 53, the interface unit 9 reschedules the content 3 for the time selected by the second user 8. Processing then proceeds to block 50 in which the interface unit 9 switches the television to the first operational mode and, to block 51, in which the second user 8 resumes watching broadcast television shows.

If choice (c) is selected in block 47, processing proceeds directly to block 51 so that the second user 8 resumes watching broadcast television shows.

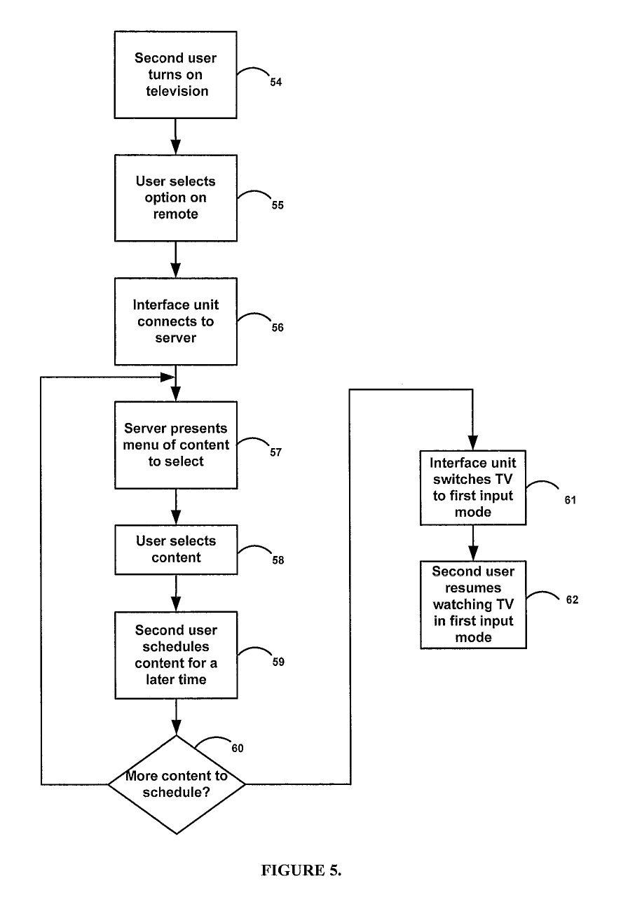

FIG. 5 is a flowchart of a method for interactive education and management according to a preferred and non-limiting embodiment in which a user interacts with a television and an interface unit to schedule content. A second user 8 may schedule: (a) content selected by the first user, but at times and/or dates that are different from those scheduled by the first user 6, or (b) content that has not been selected by the first user 6, at times and/or dates desired by the second user 8. In block 54, the second user 8 turns on the television 13. In block 55, the second user 8 uses the remote control 14 to select the option, which, as shown in block 56, instructs the interface unit 9 to connect the television 13 to the server 1, which is a fourth operational mode. In block 57, the server 1 presents a menu on the television 13 with a list of content selections, e.g., educational videos and second user status questions. In block 58, the second user 8 selects content 3 from the menu and, in block 59, the second user 8 schedules the content 3 for a future date, time, and/or for recurring viewings, time intervals. The server queries the second user 8 to determine if additional content is to be selected and scheduled in block 60. If the second user 8 desires to schedule additional content, the process flow loops back to block 57. If the second user 8 does not desire to select additional content, the server 1 connects the television 13 to the interface unit 9 in block 61, and the interface unit 9 switches the television 13 to the first operational mode so that the second user 8 may continue watching commercial programming in block 62.

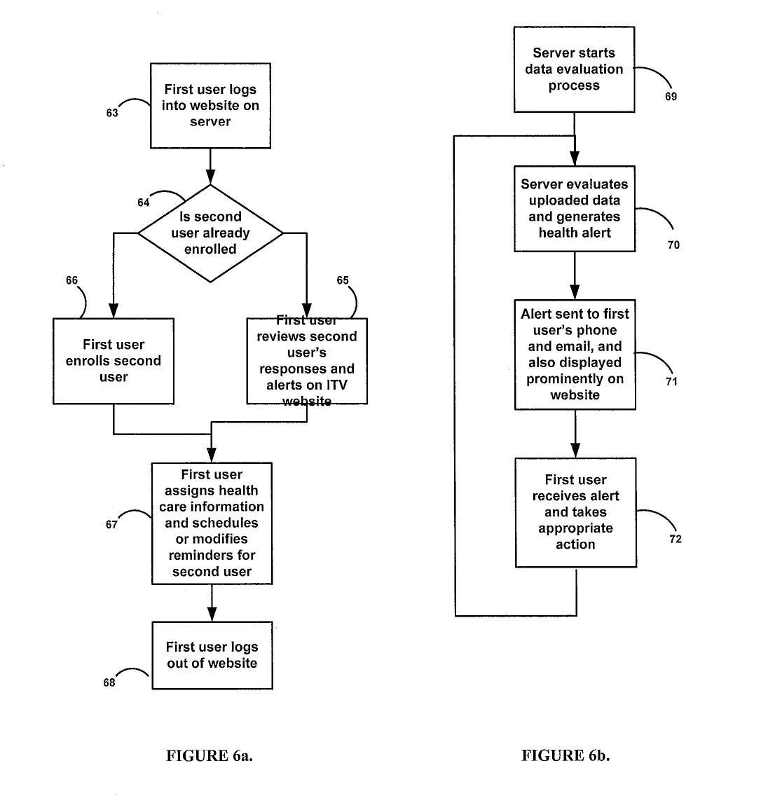

FIGS. 6A and 6B are flowcharts of a method for interactive education and management according to a preferred and non-limiting embodiment in which a provider interacts with a server and receives alerts from the server when the alerts are generated by a user interacting with the television. FIG. 6A illustrates how a first user 6 selects and schedules content and reviews second user data 10. FIG. 6B illustrates a process for health alerts.

In FIG. 6A, block 63, a first user 6 logs into the first user website 2 via an Internet browser using a secure login method. A first question that the first user 6 may be required to answer, in block 64, is whether the second user 8 is already enrolled on the first user website 2. If the second user 8 is already enrolled, and no information about the second user 8 has changed, the first user 6 may review reports on the first user website 2 with second user data 10 in block 65. If the second user 8 has not been enrolled on the first user website 2, the first user 6 may enroll the second user 8 in block 66. The first user 6 enrolls the second user 8 by entering information about the second user 8 via the forms provided on the first user website 2 with the information being stored in a database on the server 1. In either case, the first user 6 can now enter and schedule content for the second user 8, or delete or reschedule previously scheduled content for the second user 8 in block 67. The first user 6 selects content 3 from a list on the first user website 2. The selected content 3 is viewed by the second user 8 either at scheduled times or when requested by the second user 8. Content 3 that is downloaded once to the television 13 may be stored in the memory of the interface unit 9 so that subsequent access to the content 3 is faster. When the first user 6 has completed work on the first user website 2, the first user 6 may log out of the first user website 2 in block 68.

In FIG. 6B, the process begins at reference no. B, which carries over from FIG. 4, where the second user 8 views and interacts with the content 3 on the television 13. In block 69, the server 1 begins a process to continually evaluate uploaded data. In block 70, the server 1 evaluates uploaded data and generates a health alert. For example, a health alert may occur when the second user's 8 blood pressure has exceeded a pre-set limit In block 71, the alerts are transmitted by the server 1 to the first user 6 and are viewable on the first user website 2. The alert messages may be communicated by the server 1 to the first user 6 by other communication means such as e-mails, text messages, and phone calls. In block 72, the first user 6 receives the alert via one or more of the aforementioned communication methods and the process loops back to block 70 where the server 1 can evaluate new uploaded data.

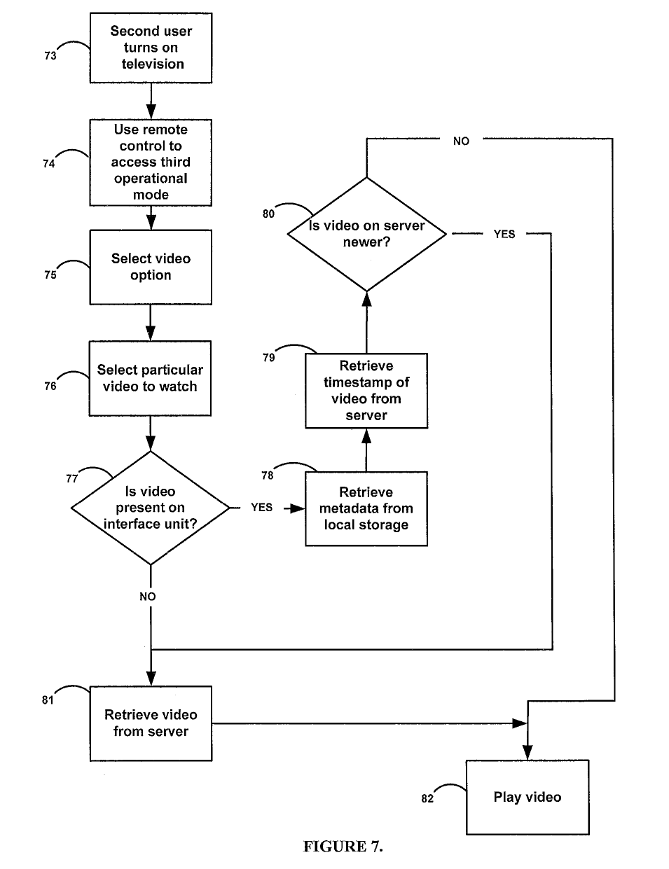

FIG. 7 is a flowchart of a method for interactive education and management according to a preferred and non-limiting embodiment in which an interface unit provides video caching. Video caching is particularly beneficial for a second user 8 who does not have a high-speed Internet connection. If the second user 8 requests a video that is already stored on the interface unit 9, the video may be immediately available on the television 13 for immediate viewing, whether scheduled via the server 1 and interface unit 9 or an ad hoc request by the second user 8. Each video may have a unique serial number and time stamp that categorizes the video by content and that determines if and when a video needs to be updated.

The detailed processing flow in FIG. 7 begins with the second user 8 turning on the television 13 in block 73. The second user 8 uses the remote control 14 to access the third operational mode in block 74 and select the video option in block 75. The second user 8 selects the desired video from the menu in block 76. The interface unit 9 determines if the video is present in the interface unit storage in block 77. If the video is present, the interface unit 9 retrieves the video and related metadata (including the timestamp) from its database in block 78. In block 79, the interface unit 9 retrieves a timestamp for the same video from the server 1. In block 80, the interface unit 9 compares the time stamps of the two videos to determine the most recent version. If the server version is the most recent version, the interface unit 9 retrieves the video from the server in block 81 and enables the second user 8 to view the video in block 82. If the video already stored in the interface unit 9 is the most recent version or the same version, then the interface unit 9 allows the second user 8 to view the video in block 82. If the video is not present on the interface unit 9 in block 77, the interface unit 9 retrieves the video from the server 1 in block 81 and enables the second user 8 to view the video in block 82.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for interactive education and management, the method comprising:
storing, by a server including a processor, a plurality of different items of media content;
receiving, by the server, first user input from at least one first user;
associating, by the server, at least one item of media content of the plurality of different items of media content with at least one second user of a plurality of different second users based at least partly on the first user input;
associating, by the server, at least one other item of media content of the plurality of different items of media content with at least one other second user of the plurality of different second users based at least partly on the first user input;
providing, by the server, the at least one item of media content to reproduction equipment of the at least one second user for reproducing the at least one item of media content;
receiving, by the server, user response data from the at least one second user in response to reproduction of the at least one item of media content on the reproduction equipment; and
transmitting, by the server, information based on the user response data to a first user device of the at least one first user.

2. The method of claim 1, further comprising:
associating, by the server, the at least one item of media content with at least one scheduled time based at least partly on the first user input; and
providing, by the server, the at least one item of media content to the reproduction equipment of the at least one second user at the scheduled time.

3. The method of claim 2, further comprising:
interrupting, by the server, reproduction of programming content by the reproduction equipment such that the reproduction equipment reproduces the at least one item of media content instead of, or in addition to, the programming content at the scheduled time;
setting, by the server, the at least one scheduled time to at least one rescheduled time based at least partly on the user response data such that the reproduction equipment resumes reproduction of the programming content without reproducing the at least one item of media content; and
interrupting, by the server, reproduction of the programming content by the reproduction equipment such that the reproduction equipment reproduces the at least one item of media content instead of, or in addition to, the programming content at the at least one rescheduled time.

4. The method of claim 2, further comprising:
interrupting, by the server, reproduction of programming content by the reproduction equipment such that the reproduction equipment reproduces the at least one item of media content instead of, or in addition to, the programming content at the scheduled time; and
controlling, by the server, the reproduction equipment to continue reproducing the at least one item of media content based at least partly on the user response data.

5. The method of claim 2, further comprising:
interrupting, by the server, reproduction of programming content by the reproduction equipment such that the reproduction equipment reproduces the at least one item of media content instead of, or in addition to, the programming content at the scheduled time; and
interrupting, by the server, reproduction of the at least one item of media content by the reproduction equipment such that the reproduction equipment resumes reproduction of the programming content without reproducing the at least one item of media content based at least partly on the user response data.

6. The method of claim 1, further comprising:
receiving, by the server, a content request for the at least one item of media content from a second user device of the at least one second user;
providing, by the server, the at least one item of media content to the reproduction equipment of the at least one second user in response to the content request.

7. The method of claim 6, further comprising:
associating, by the server, the at least one item of media content with at least one scheduled time based at least partly on the content request; and
providing, by the server, the at least one item of media content to the reproduction equipment of the at least one second user at the scheduled time.

8. The method of claim 1, wherein at least a portion of the plurality of different items of media content are associated with each of the plurality of different users.

9. The method of claim 1, wherein at least a portion of the plurality of different items of media content are not associated with any of the plurality of different users.

10. The method of claim 1, wherein the plurality of different items of media content comprise text content, audio content, image content, and video content.

11. The method of claim 1, further comprising:
associating, by the server, at least one additional item of media content of the plurality of different items of media content with the at least one second user based at least partly on the user response data.

12. The method of claim 1, further comprising:
providing, by the server, an alert to at least one of the first user device, the reproduction equipment, and a second user device of the second user based at least partly on the user response data.

13. The method of claim 1, further comprising:
calling, by the server, a telephone number associated with the at least one second user during or after reproduction of the at least one item of media content on the reproduction equipment to establish a telephone connection between the server and a second user device of the at least one second user, wherein the server receives the user response data from the at least one second user via the telephone connection with the at least one second user.

14. The method of claim 1, further comprising:
calling, by the server, a telephone number associated with the at least one second user before reproduction of the at least one item of media content on the reproduction equipment to establish a telephone connection between the server and a second user device of the at least one second user, wherein the server receives additional user response data from the at least one second user via the telephone connection with the at least one second user.

15. The method of claim 1, further comprising:
providing, by the server, a first user website accessible by the at least one first user for receiving the first user input.

16. The method of claim 1, further comprising:
setting, by the server, an operational mode of the reproduction equipment to reproduce the at least one media item.

17. The method of claim 1, further comprising:
receiving, by the server, at least a portion of the user response data from at least one medical device of the at least one second user.

18. The method of claim 1, wherein the server comprises an interface unit directly connected to the reproduction equipment.

19. The method of claim 18, wherein the server communicates with the interface unit via at least one network.

20. The method of claim 1, wherein the server communicates via at least one network with an interface unit connected to the reproduction equipment, and wherein the interface unit stores the at least one item of media content associated with the at least one second user, and wherein the interface unit provides the at least one item of media content to the reproduction equipment of the at least one second user for reproducing the at least one item of media content.

21. The method of claim 20, wherein the interface unit receives the user response data from the at least one second user in response to the reproduction of the at least one item of media content on the reproduction equipment and sends the user response data to the server via the at least one network.

22. The method of claim 1, wherein the at least one first user comprises a healthcare provider, the at least one second user comprises a patient, and the at least one item of media content comprises healthcare information.

23. The method of claim 22, wherein the at least one first user further comprises at least one of a user associated with the patient and a user associated with the healthcare provider, wherein the at least one second user further comprises a user associated with the patient, and wherein at least a portion of the at least one item of media content comprises appointment information.

24. The method of claim 1, further comprising:
exchanging, by the server, data for real time communications between an audio/video recording device of the at least one first user and an audio/video recording device of the at least one second user.

25. The method of claim 24, further comprising:
storing, by the server, at least a portion of the data for real time communications as the user response data.

26. A system for interactive education and management, the system comprising:
a server computer connected to at least one network, wherein the server computer is configured to:
store a plurality of different items of media content;
receive first user input from at least one first user;
associate at least one item of media content of the plurality of different items of media content with at least one second user of a plurality of different second users based at least partly on the first user input;
associate at least one other item of media content of the plurality of different items of media content with at least one other second user of the plurality of different second users based at least partly on the first user input;
provide the at least one item of media content to reproduction equipment of the at least one second user for reproducing the at least one item of media content;
receive user response data from the at least one second user in response to reproduction of the at least one item of media content on the reproduction equipment; and
transmit information based on the user response data to a first user device of the at least one first user.

27. The system of claim 26, wherein the server computer is further configured to:
associate the at least one item of media content with at least one scheduled time based at least partly on the first user input; and
provide the at least one item of media content to the reproduction equipment of the at least one second user at the scheduled time.

28. The system of claim 27, wherein the server computer is further configured to:
interrupt reproduction of programming content by the reproduction equipment such that the reproduction equipment reproduces the at least one item of media content instead of, or in addition to, the programming content at the scheduled time;
set the at least one scheduled time to at least one rescheduled time based at least partly on the user response data such that the reproduction equipment resumes reproduction of the programming content without reproducing the at least one item of media content; and
interrupt reproduction of the programming content by the reproduction equipment such that the reproduction equipment reproduces the at least one item of media content instead of, or in addition to, the programming content at the at least one rescheduled time.

29. The system of claim 27, wherein the server computer is further configured to:
interrupt reproduction of programming content by the reproduction equipment such that the reproduction equipment reproduces the at least one item of media content instead of, or in addition to, the programming content at the scheduled time; and
control the reproduction equipment to continue reproducing the at least one item of media content based at least partly on the user response data.

30. The system of claim 27, wherein the server computer is further configured to:
interrupt reproduction of programming content by the reproduction equipment such that the reproduction equipment reproduces the at least one item of media content instead of, or in addition to, the programming content at the scheduled time; and
interrupt reproduction of the at least one item of media content by the reproduction equipment such that the reproduction equipment resumes reproduction of the programming content without reproducing the at least one item of media content based at least partly on the user response data.

31. The system of claim 26, wherein the server computer is further configured to:
receive a content request for the at least one item of media content from a second user device of the at least one second user; and
provide the at least one item of media content to the reproduction equipment of the at least one second user in response to the content request.

32. The system of claim 31, wherein the server computer is further configured to:
associate the at least one item of media content with at least one scheduled time based at least partly on the content request; and
provide the at least one item of media content to the reproduction equipment of the at least one second user at the scheduled time.

33. The system of claim 26, wherein at least a portion of the plurality of different items of media content are associated with each of the plurality of different users.

34. The system of claim 26, wherein at least a portion of the plurality of different items of media content are not associated with any of the plurality of different users.

35. The system of claim 26, wherein the plurality of different items of media content comprise text content, audio content, image content, and video content.

36. The system of claim 26, wherein the server computer is further configured to:
associate at least one additional item of media content of the plurality of different items of media content with the at least one second user based at least partly on the user response data.

37. The method of claim 26, wherein the server computer is further configured to:
provide an alert to at least one of the first user device, the reproduction equipment, and a second user device of the second user based at least partly on the user response data.

38. The system of claim 26, wherein the server computer is further configured to:
call a telephone number associated with the at least one second user during or after reproduction of the at least one item of media content on the reproduction equipment to establish a telephone connection between the server and a second user device of the at least one second user; and
receive the user response data from the at least one second user via the telephone connection with the at least one second user.

39. The method of claim 26, wherein the server computer is further configured to:
call a telephone number associated with the at least on second user before reproduction of the at least one item of media content on the reproduction equipment to establish a telephone connection between the server and a second user device of the at least one second use; and
receive additional user response data from the at least one second user via the telephone connection with the at least one second user.

40. The system of claim 26, wherein the server computer is further configured to provide a first user website accessible by the at least one first user for receiving the first user input.

41. The system of claim 26, wherein the server computer is further configured to set an operational mode of the reproduction equipment to reproduce the at least one media item.

42. The system of claim 26, wherein the server computer is further configured to receive at least a portion of the user response data from at least one medical device of the at least one second user.

43. The system of claim 26, wherein the server comprises an interface unit directly connected to the reproduction equipment.

44. The system of claim 43, wherein the server communicates with the interface unit via the at least one network.

45. The system of claim 26, further comprising:
an interface unit directly connected to the reproduction equipment, wherein the server computer communicates via the at least one network with the interface unit, wherein the interface unit stores the at least one item of media content associated with the at least one second user, and wherein the interface unit provides the at least one item of media content to the reproduction equipment of the at least one second user for reproducing the at least one item of media content.

46. The system of claim 45, wherein the interface unit receives the user response data from the at least one second user in response to the reproduction of the at least one item of media content on the reproduction equipment and sends the user response data to the server computer via the at least one network.

47. The system of claim 26, wherein the at least one first user comprises a healthcare provider, the at least one second user comprises a patient, and the at least one item of media content comprises healthcare information.

48. The system of claim 47, wherein the at least one first user further comprises at least one of a user associated with the patient and a user associated with the healthcare provider, and wherein the at least one second user further comprises a user associated with the patient, and wherein at least a portion of the at least one item of media content comprises appointment information.

49. The method of claim 26, wherein the server is further configured to exchange data for real time communications between an audio/video recording device of the at least one first user and an audio/video recording device of the at least one second user.

50. The method of claim 49, wherein the server is further configured to store at least a portion of the data for real time communications as the user response data.

51. A non-transitory computer readable medium storing a computer program which when executed by a processor of a computer performs a method for interactive education and management, the method comprising:
storing plurality of different items of media content;
receiving first user input from at least one first user;
associating at least one item of media content of the plurality of different items of media content with at least one second user of a plurality of different second users based at least partly on the first user input;
associating at least one other item of media content of the plurality of different items of media content with at least one other second user of the plurality of different second users based at least partly on the first user input;
providing the at least one item of media content to reproduction equipment of the at least one second user for reproducing the at least one item of media content;
receiving user response data from the at least one second user in response to reproduction of the at least one item of media content on the reproduction equipment; and
transmitting information based on the user response data to a first user device of the at least one first user.
